(19) United States
(12) Patent Application Publication
(10) Pub. No.: US 2011/0047779 A1
(43) Pub. Date: Mar. 3, 2011

(54) METHOD FOR MAKING MOLDS WITH 3-DIMENSIONAL COOLING PATHS

(76) Inventors: SEN YUNG LEE, TAINAN CITY (TW); CHUIH-KUAN WANG, TAINAN COUNTY (TW); Y LIN CHENG, KAOHSIUNG CITY (TW); SHENG-JYE HUANG, TAINAN CITY (TW); NAI-TSUN HUANG, KAOHSIUNG COUNTY (TW)

(21) Appl. No.: 12/861,199

(22) Filed: Aug. 23, 2010

(30) Foreign Application Priority Data
Aug. 28, 2009 (TW) 098128948

(51) Int. Cl. B23P 17/00

(52) U.S. Cl. 29/527.1

(57) ABSTRACT

A method for making molds with curved cooling paths includes a step of obtaining a drawing of a mold by using computers and the drawing including the positions of concavities, cooling paths and reference points; a step of manufacturing the mold by way of pour casting according to the drawing so as to obtain a mold having the concavities, the cooling paths and the reference points, and a step of trimming the concavities of the mold according to the reference points and opening two ends of each of the cooling paths to obtain a final mold.

### FIELD OF THE INVENTION

The present invention relates to a method for making molds, and more particularly, to a method for making molds having 3-dimensional cooling paths.

### BACKGROUND OF THE INVENTION

A conventional method for making molds is to use proper software to obtain a design by using computers and the design is transformed into a drawing which is then input to the CNC machine. A steel block is machined by the CNC machine to mill, drill and/or cut according the stored drawing. The steel block then has concavities at desired positions. When using the mold to produce products, the melted material is poured into the concavities and the temperature of the melted material is so high that the concavities might be deformed because of the significant temperature difference in the mold and outside of the mold. The temperature difference can affects the specification of the products formed in the concavities. In order to remove the high temperature when pouring the melted material into the mold, cooling paths have to be made in the mold and the way to make the cooling paths in the mold is to drill paths directly by using drilling machine.

The best allocation of the cooling paths is to be located as close to the concavity as possible so as to evenly remove the high temperature from the concavities. Preferably, the cooling paths are located according to the profile of each of the concavities. However, the cooling paths made by way of drilling in the mold can only be drilled close to the concavities and all of the cooling paths are straight which extends in X-axis and Y-axis. The straight cooling paths cannot be matched the profile of the concavities so that the efficiency of removing heat is limited.

There are several drawbacks for the conventional method for making the molds, the first drawback is that the cost is too high. Because the mold is made from one whole steel block so that some parts of the steel material have to be removed when making the concavities. When drilling the cooling paths, extra steel material is further removed. In addition, the steps for making the concavities and cooling paths are taken individually so that the time required is significant.

Secondly, because the cooling paths are made after the concavities are made, and the drilling machine can only drill in straight direction so that all of the cooling paths are straight. However, the shapes of the concavities may have curvature so that the distance between each part of the concavities and the straight cooling paths is different and the efficiency for removing the heat is different.

Furthermore, the concavities have to be made first and then the cooling paths are made, the time required is prolonged and the manufacturing efficiency is low.

The present invention intends to provide a method for making cooling paths of molds and the cooling paths are curved according to the shape of the concavities.

### SUMMARY OF THE INVENTION

The present invention relates to a method for making molds with curved cooling paths, and the method comprising the following steps:
step a: obtaining a drawing of a mold by using computers and the drawing including the positions of concavities, cooling paths and reference points;
step b: manufacturing the mold by way of pour casting according to the drawing so as to obtain a mold which includes the concavities, the cooling paths and the reference points, and
step c: trimming the concavities of the mold according to the reference points and opening two ends of each of the cooling paths to obtain a final mold.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a flow chart of the method of the present invention;

FIG. 2 shows the mold in each of the steps of the method of the present invention, and

FIG. 3 is a cross sectional view of the final mold made by the method of the present invention.

### DETAILED DESCRIPTION OF THE PREFERRED EMBODIMENT

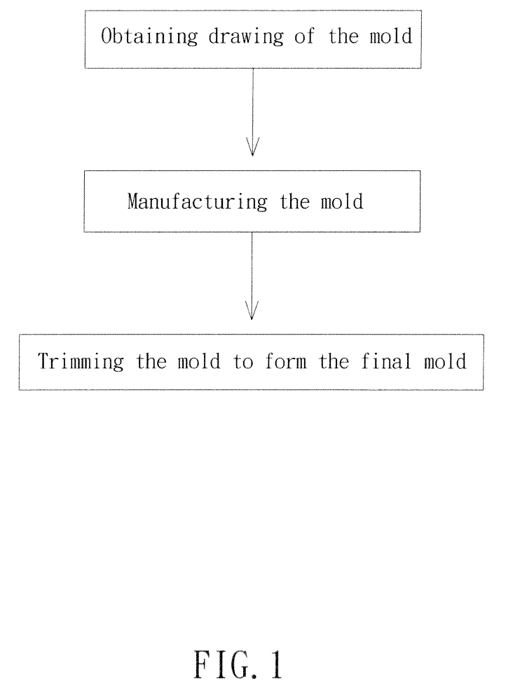

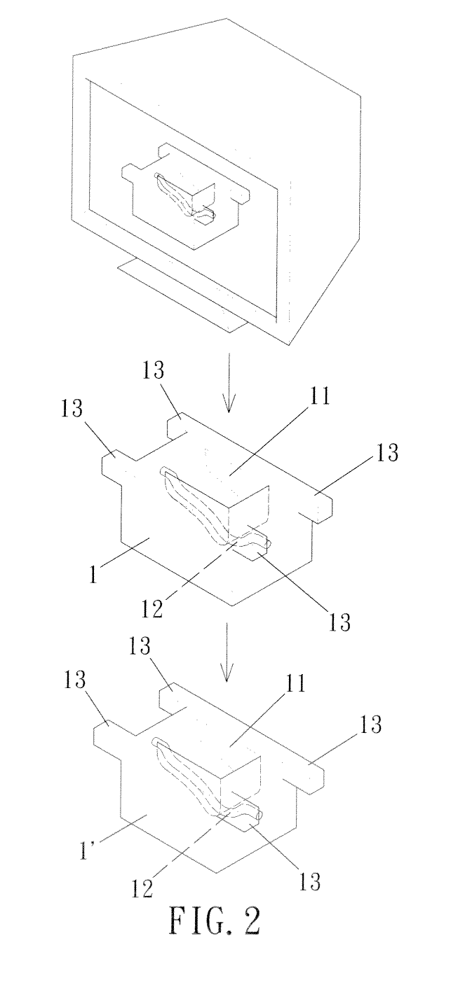

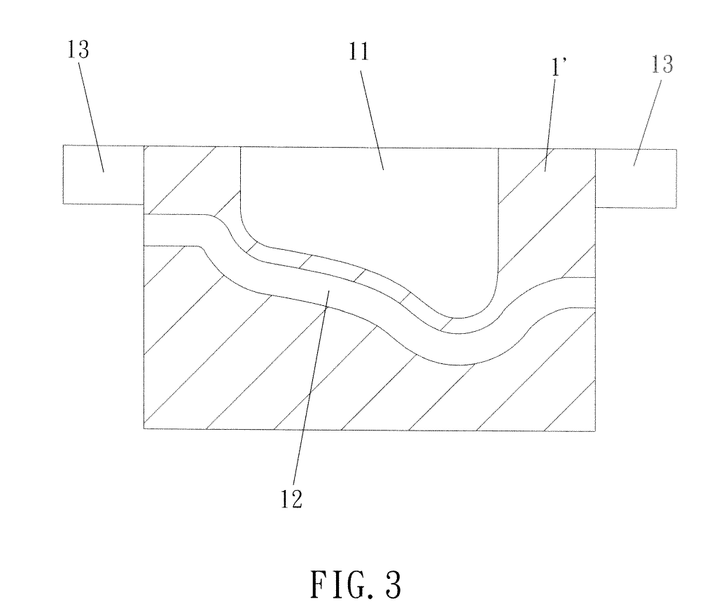

Referring to FIGS. 1 to 3, the method for making a mold with curved cooling paths of the present invention comprises the following steps:
step a: obtaining a drawing of a mold by using computers and the drawing including the positions of concavities 11, cooling paths 12 and reference points 13;
step b: manufacturing the mold by way of pour casting according to the drawing so as to obtain a mold 1 which includes the concavities 11, the cooling paths 12 and the reference points 13, and
step c: trimming the concavities 11 of the mold 1 according to the reference points 13 and opening two ends of each of the cooling paths 12 to obtain a final mold 1′.

By the method provided by the present invention, the final mold 1′ can be made integrally and has the concavities 11, the cooling paths 12 and the reference points 13.

The present invention can make the final mold 1′ at low cost because the final mold 1′ is made integrally with the concavities 11 and the cooling paths 12 so that the time and steps required are reduced and the steps are simplified.

Because the cooling paths 12 are curved which are located beside the concavities 11 at even distance so that the heat dispensing feature is improved and the problem of deformation of the concavities 11 is improved. The mold is integrally made by way of casting so that only simple and easy trimming steps needed to be taken to have the final mold 1′ so that the efficiency of manufacturing is increased and time required is reduced.

While we have shown and described the embodiment in accordance with the present invention, it should be clear to those skilled in the art that further embodiments may be made without departing from the scope of the present invention.

What is claimed is:

1. A method for making molds with curved cooling paths, comprising:
step a: obtaining a drawing of a mold by using computers and the drawing including the positions of concavities, cooling paths and reference points;
step b: manufacturing the mold by way of pour casting according to the drawing so as to obtain a mold which includes the concavities, the cooling paths and the reference points, and
step c: trimming the concavities of the mold according to the reference points and opening two ends of each of the cooling paths to obtain a final mold.
